(19) United States
(12) Patent Application Publication
(10) Pub. No.: US 2015/0163988 A1
(43) Pub. Date: Jun. 18, 2015

(54) DISC IMPLEMENT WITH ANGLE ADJUSTMENT

(71) Applicant: Schulte Industries Ltd., Engelfeld (CA)

(72) Inventors: Greg SWANSON, Saskatoon (CA); Todd HOFMANN, Saskatoon (CA)

(21) Appl. No.: 14/547,769

(22) Filed: Nov. 19, 2014

(30) Foreign Application Priority Data
Nov. 20, 2013 (CA) 2833682

(51) Int. Cl. A01B 63/02; A01B 5/04

(52) U.S. Cl. CPC A01B 63/023; A01B 5/04

(57) ABSTRACT

A disc tillage implement has an implement frame mounted on wheels for movement along the ground. A plurality of disc assemblies is substantially equally spaced along a lateral frame member, each disc assembly comprising a pivot bracket pivotally attached to the lateral frame member about a substantially vertical bracket pivot axis, and a disc arm attached to a lower portion of the pivot bracket, with a disc rotatably attached to a bottom end of the disc arm. A control mechanism pivots the pivot brackets of each disc assembly about the corresponding bracket pivot axis of each disc assembly to a selected operating position.

### BACKGROUND

Disc tillage implements used in agriculture have a plurality of discs rotatably mounted to an implement frame. These disc implements are available in a wide variety of configurations. The discs can be flat, concave, or have a rippled or spoked perimeter, and the rotational axis of the discs may be oriented in a range from perpendicular to the operating travel direction, such that the disc simply cuts a slit in the soil surface with negligible lateral soil movement, to 20 degrees or more off perpendicular where the angled disc orientation causes considerable lateral soil movement.

When the rotational axis of the discs is oriented at an angle other than perpendicular to the operating travel direction, a leading face of the disc pushes soil laterally. The rotational axis of the discs can be horizontal, or may be tilted vertically such that the leading face of the disc lifts soil upward. In this tilted orientation, lifted soil exerts a downward force on the disc that helps the disc to penetrate hard soil. It is well known to orient the discs at a compound angle such that the leading face of the disc both moves soil laterally and lifts the soil upward.

Thus depending on the particular object of the tillage operation, a farmer can select a suitable disc implement and orientation. To reduce ridging from lateral soil movement, tillage discs are commonly mounted with rotational axes thereof in alignment such that soil moved laterally by one disc falls generally into the location where the adjacent disc has removed soil. This aligned mounting is commonly achieved by mounting a plurality of such discs on an single axle to form a disc “gang”. The axle is mounted to a frame member on bearing hangers, and several gangs may be mounted in alignment on one or more frame members to provide a wider implement section with all discs aligned. Such a disc arrangement is illustrated for example in U.S. Pat. No. 7,108,075 to Powell et al.

To allow the operator to vary the amount of lateral soil movement it is also known to adjust the orientation of the frame member or members to which the disc gangs are mounted. When more lateral soil movement is desired, the angle of the rotational axis of the discs with respect to the operating travel direction is increased, and when less lateral soil movement is desired the angle is decreased. Such an angle adjustment is also disclosed by Powell.

Powell discloses an disc implement with a single row of discs along the front of the implement. The discs on the right half of the implement are oriented at an angle to the operating travel direction that is opposite to the orientation of the discs on the left side. This is a common configuration of discs, as such an equal ,and opposite disc orientation on right and left sides of the implement equalizes side draft caused by the soil forces exerted laterally on the leading faces of the discs.

U.S. Pat. No. 8,074,728 to Kovach et al. illustrates a common disc tillage implement with front and rear rows of aligned discs. The discs on the front right half of the implement are oriented at an angle to the operating travel direction that is opposite to the orientation of the discs on the front left side, and also opposite to the orientation of the discs on the rear right side. Correspondingly, the discs on the front left half of the implement are oriented at an angle to the operating travel direction that is opposite to the orientation of the discs on the front right side, and also opposite to the orientation of the discs on the rear left side. Again this configuration substantially equalizes the side draft on the implement.

Disc implements such as disclosed by Kovach are well known. The front and rear rows of discs must be separated by enough distance to allow the disc angle to be adjusted through the desired range. In order to follow ground contours while maintaining a constant tillage depth of disc penetration it is desirable to have front and rear rows as close together as possible. Implements such as that of Kovach with a significant distance between the front and rear rows do not maintain consistent tillage depth in rolling ground contours.

U.S. Pat. No. 8,534,374 to Hake et al. discloses a disc tillage implement with front and rear rows of shorter disc gangs where the angle of adjacent disc gangs can be adjusted individually. The rotational axis of discs on one gang may be at the same angle as an adjacent gang, but here the rotational axes of the adjacent gangs are not aligned. A reduced distance between the front and rear rows of discs is possible with the Hake implement.

In the Twister™ disc implement, manufactured by Mandako Agri Marketing Inc. of Plum Coulee, Manitoba, Canada, a plurality of disc assemblies, each with two discs, are mounted to a lateral frame member to form the disc gang. Each disc assembly comprises an arm pivotally attached to the lateral frame member and an axle mounted at a midpoint thereof to the bottom end of the arm with a disc on each end of the axle. The arm can pivot up and down against a bias force to allow the discs to move upward when an obstruction, such as a rock, is struck. The lateral frame member can be moved to change the angle of the disc gang with respect to the operating travel direction.

Disc implements with no disc angle adjustment are also known, and are sometimes referred to as “compact” disc implements since the front and rear rows of discs can be very close together. The discs are aligned across the entire width of the implement, and typically are oriented with rotational axes at an angle to the operating travel direction such that there is a degree of lateral soil movement. Examples of such compact disc implements are the Rubin™ disc implement manufactured by Lemken GMBH & Co. KG of Alpen, Germany, and the Joker™ disc implement manufactured by Horsch Anderson of Andover, S.D., USA. These compact disc implements with the front and rear rows of discs close together can follow rolling ground contours with more consistent tillage depth.

### SUMMARY OF THE INVENTION

The present disclosure provides a disc tillage implement that overcomes problems in the prior art.

The present disclosure provides a disc tillage implement comprising an implement frame mounted on wheels for movement along the ground in an operating travel direction, the implement frame comprising a lateral frame member. A plurality of disc assemblies is substantially equally spaced along the lateral frame member, each disc assembly comprising a pivot bracket pivotally attached to the lateral frame member about a substantially vertical bracket pivot axis, and a disc arm attached to a lower portion of the pivot bracket, with a disc rotatably attached to a bottom end of the disc arm. A control mechanism is operative to pivot the pivot brackets of each disc assembly about the corresponding bracket pivot axis of each disc assembly to a selected operating position.

The small amount of back and forth movement when changing the angle of the discs with respect to the operating travel direction allows the front and rear rows of discs to be close together as in conventional “compact” disc implements to follow rolling ground contours while maintaining good consistency of tillage depth between the front and rear rows of discs, while also allowing the angle of the discs to be changed. Thus the operator can readily vary the amount of lateral soil movement to suit the object of a wide variety of field operations.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a top view of an embodiment of a disc tillage implement of the present disclosure;

FIG. 2 is a front perspective view of the front corner of the embodiment of FIG. 1, with the control arm positioned to orient the rotational axes of the discs perpendicular to the operating travel direction such that negligible lateral soil movement is imparted by the discs;

FIG. 3 is a front perspective view of the front corner of the embodiment of FIG. 1, with the control arm positioned to orient the rotational axes of the discs at an angle that is not perpendicular to the operating travel direction such that a degree of lateral soil movement is imparted by the leading faces of the discs;

FIG. 4 is a side view of a disc assembly of the embodiment of FIG. 1, with the disc arm in the operating position, and with the raised position of the disc arm shown in phantom lines;

FIG. 5 is a rear perspective view of a disc assembly of the embodiment of FIG. 1, with the disc arm in the operating position;

FIG. 6 is a rear view of a disc assembly of the embodiment of FIG. 1, with the disc arm in the operating position;

FIG. 7 is a top view of an alternate disc assembly with the disc arm in the operating position, where the rotational axes of the discs are tilted from horizontal, such that soil is lifted by the leading faces of the discs;

FIG. 8 is a rear view of the disc assembly of FIG. 7;

FIG. 9 is a top view of a plurality of disc assemblies of the embodiment of FIG. 1 showing the forward and rearward movement of the right and left discs when the pivot brackets pivot to change the angle of the rotational axes with respect to the operating travel direction;

FIG. 10 is a schematic top view showing the increased forward and rearward movement of the right and left discs when the bracket pivot axis is moved forward from the rotational angle of the discs.

### DETAILED DESCRIPTION OF THE ILLUSTRATED EMBODIMENTS

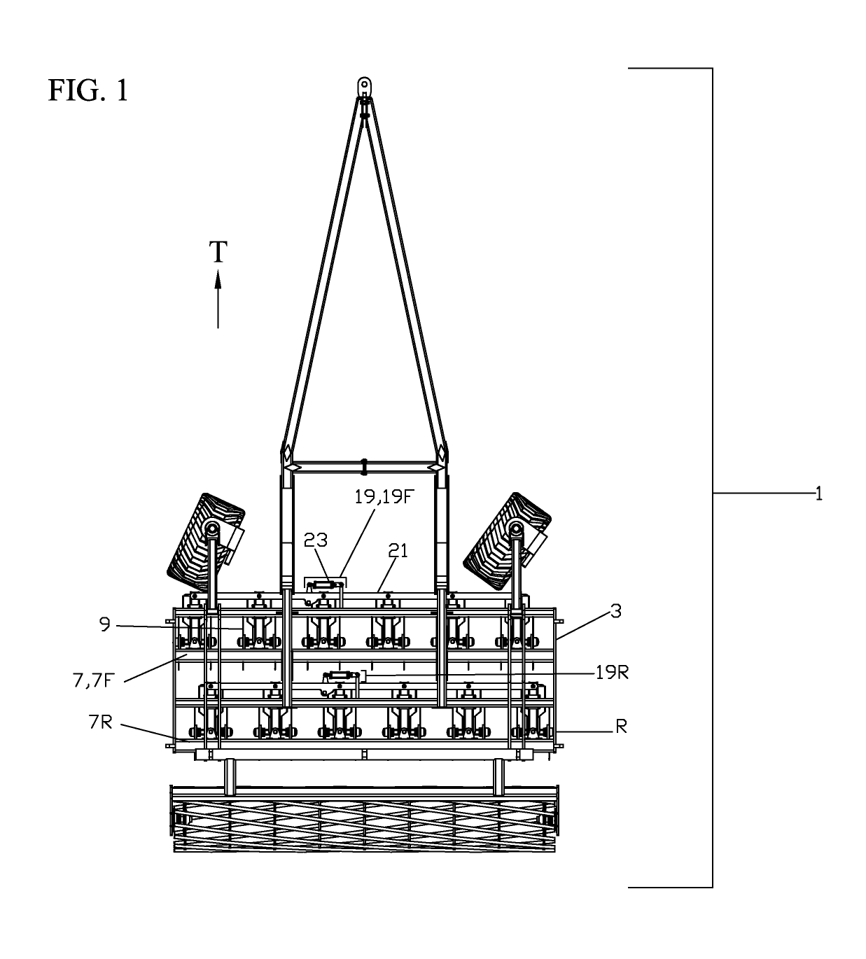

FIGS. 1-3 illustrate an embodiment of a disc tillage implement 1 of the present disclosure. The implement 1 comprises an implement frame 3 mounted on wheels 5 for movement along the ground in an operating travel direction T. The caster wheels 5 pivot as illustrated to allow the implement to turn. The illustrated implement frame 3 comprises a lateral frame member 7.

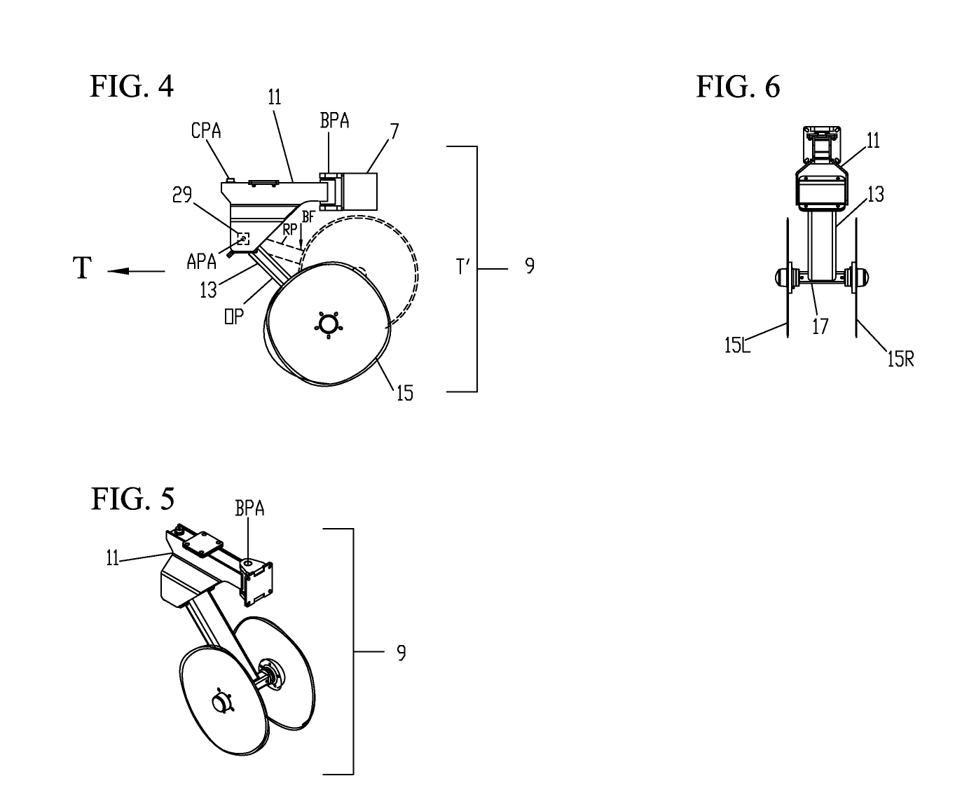

A plurality of disc assemblies 9 are substantially equally spaced along the lateral frame member 7. As shown in FIGS. 4-6, each disc assembly comprises a pivot bracket 11 pivotally attached to the lateral frame 7 member about a substantially vertical bracket pivot axis BPA, and a disc arm 13 attached to a lower portion of the pivot bracket 11 with a disc 15 rotatably attached to a bottom end of the disc arm 13. While it is contemplated that the disc assembly could have a single disc 15 mounted to the bottom end of the arm 13, the illustrated disc assemblies 9 comprise an axle member 17 attached at a mid-point thereof to the bottom end of the disc arm 13, and right and left discs 15R, 15L rotatably attached to corresponding right and left ends of the axle member 17.

A control mechanism 19 is operative to pivot the pivot brackets 11 of each disc assembly 9 about the corresponding bracket pivot axis BPA of each disc assembly 9 to a selected operating position. In the illustrated implement 1, the pivot brackets 11 extend forward from the lateral frame member 7 to a distal end thereof, and the control mechanism 19 comprises a control bar 21 pivotally attached to a distal portion of each pivot bracket 11 about a substantially vertical control pivot axis CPA, and an actuator 23 operative to move the control bar 21 laterally. As the actuator 23 moves the control bar 21 laterally, each pivot bracket 11 connected thereto moves the same amount, such that the discs 15 are oriented at the same angle with respect to the operating travel direction T.

The actuator 23 can be provided by an extendable cylinder, or by a rotating motor and gear mechanism, or any like mechanism that can move the control bar 21 to the selected operating position and then maintain same in that position until activated to move the control arm to a different selected operating position.

It is contemplated that the pivot brackets 11 could extend rearward from the lateral frame member 7 as well. For example in FIG. 4, the operating travel direction of the implement 1 is indicated by arrow T with the pivot bracket 11 extending forward. The operating travel direction could also be as indicated by the arrow T′ with the pivot bracket 11 extending rearward.

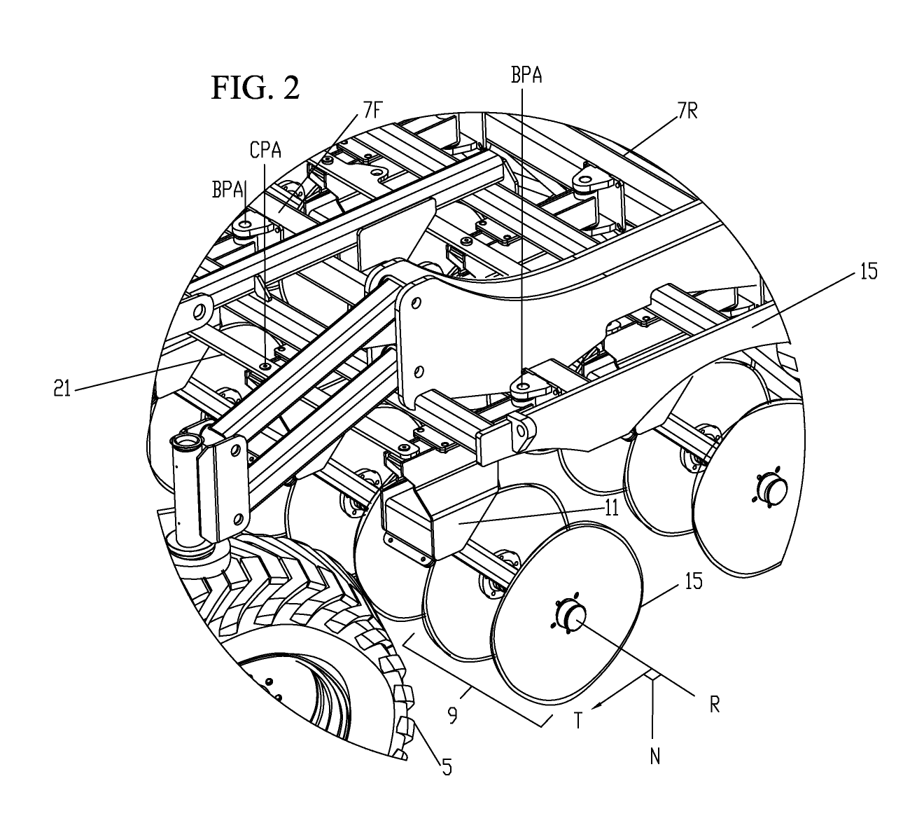

The illustrated implement 1 has front and rear lateral frame members 7F, 7R and a plurality of disc assemblies 9 substantially equally spaced along each of the front and rear lateral frame members 7F, 7R. Front and rear control mechanisms 19F, 19R control the corresponding disc assemblies 9 on the front and rear lateral frame members 7F, 7R In FIGS. 1 and 2, the control mechanisms 19 are shown with the control bar 21 located such that in the illustrated selected operating position the rotational axes R of the discs 15 of each disc assembly 9 are at an angle N that is perpendicular to the operating travel direction T, such that the discs 15 simply cut a slit in the soil surface with negligible lateral soil movement.

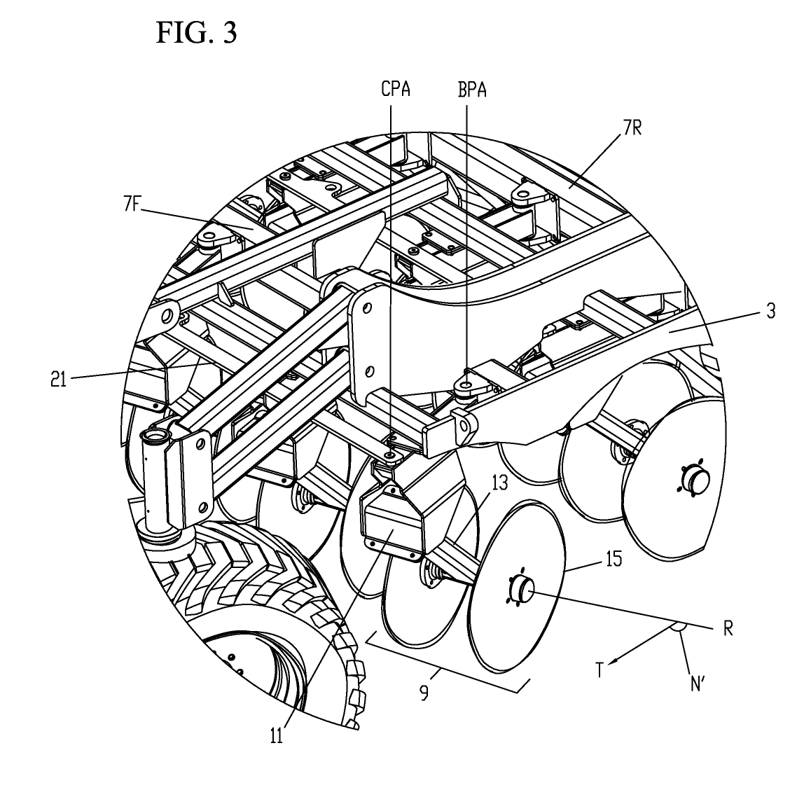

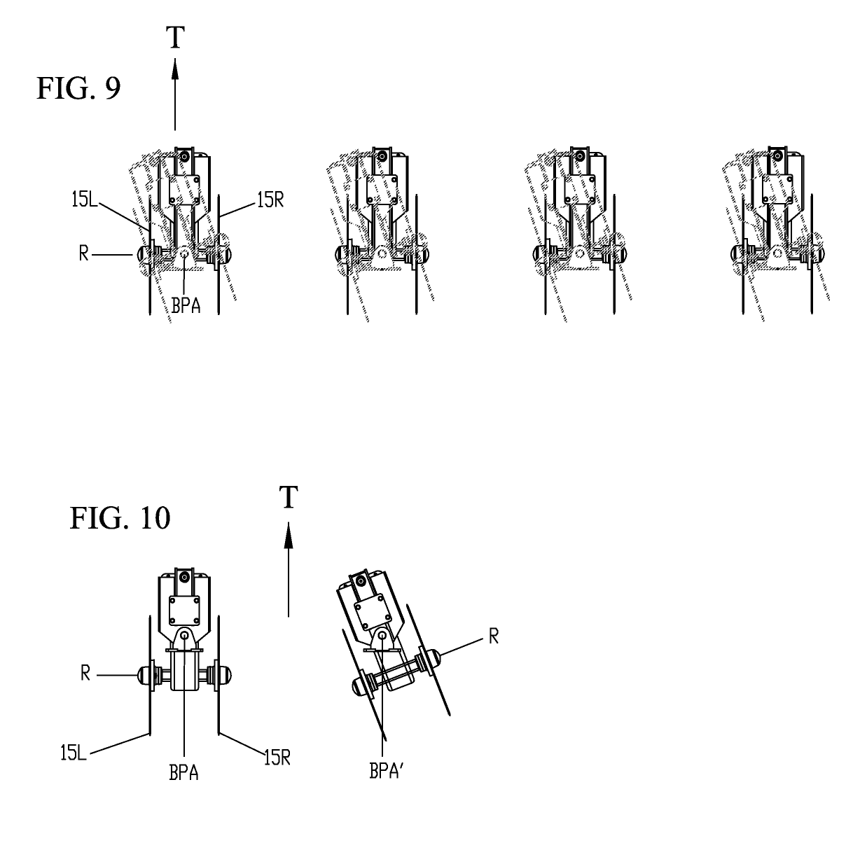

In FIG. 3, the control arms 19 have been moved such that the rotational axes R of the discs 15 are at an angle N′ to the operating travel direction T. This operating position is schematically illustrated in the top view of FIG. 9, where it can also be seen that on each disc assembly 9, the bracket pivot axis BPA substantially coincides with the rotational axis of the discs 15. With this configuration, the center of the axle member 17 rotates about the bracket pivot axis BPA, such that the right disc 15R moves somewhat forward and the left disc 15L moves somewhat rearward. This movement is minimized by locating the bracket pivot axis BPA at the rotational axis R of the discs, compared to the configuration schematically illustrated in FIG. 10 where the bracket pivot axis BPA′ is forward of the rotational axis R.

The small forward and rearward movement of the discs 15 means the discs in each row remain substantially aligned as the angle is changed such that soil ridging is reduced. Also the front and rear rows of discs 15 can be close together, allowing the implement 1 to follow rolling ground contours while maintaining a more consistent tillage depth.

To allow the discs 15 in each disc assembly 9 to move upward when encountering an obstruction and thus reduce damage, in the illustrated implement 1 the disc arm 13 is pivotally is attached to a lower portion of a distal portion of the pivot bracket 11 about a substantially horizontal arm pivot axis APA such that the disc arm 13 can pivot upward as schematically illustrated in FIG. 4, from an operating position OP to a raised position RP shown in phantom lines. A bias element 25 is operative to exert a downward bias force BF on the disc arm 13 when the disc arm 13 moves upward away from the operating position OP, such as when striking a stone in the field. Conveniently the arm 13 is pivotally attached to pivot bracket 11 by a rubber suspension unit 29, such as is available from Rosta AG of Hunzenschwil, Switzerland. These rubber suspension units 29 provide a pivotal mount of the arm 13 to the bracket 11, and also urge the arm 13 back into the operating position when the arm 13 is forced away from the operating position by an obstruction. A conventional trip mechanism or spring bias mechanism could be used as well.

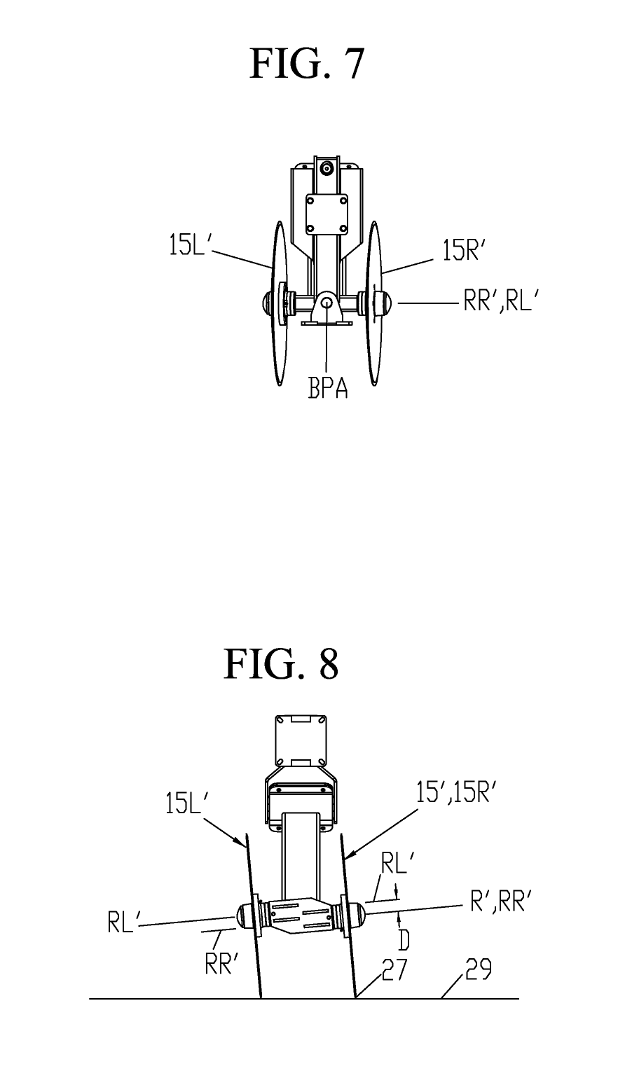

In the implement 1, the rotational axes R of the discs 15 is horizontal. FIGS. 7 and 8 illustrate corresponding top and rear views of an alternate orientation of the discs 15′ where the rotational axes R′ tilted from horizontal such that the leading faces 15A′ of discs 15′ lift the soil. The rotational axes RR′, RL′ of the right and left discs 15R′, 15L′ are in alignment when seen from above in FIG. 7 and are oriented one above the other as seen in FIG. 8. The distance D between the right and left rotational axes RR′, RL′ is selected to position the lower edges 27 of the right and left discs 15R′, 15L′ at the same vertical position such that same will engage the soil surface 29 to the same depth.

In the disc tillage implement of the present disclosure the front and rear rows of discs 15 can be close together since there is little back and forth movement when changing the angle of the discs 15 with respect to the operating travel direction T. Thus a disc implement is provided with front and rear disc rows close together as in the conventional “compact” disc implement, while also allowing the angle of the discs to be changed to vary the amount of lateral soil movement, making the implement suitable for a wider variety of conditions.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A disc tillage implement comprising:
an implement frame mounted on wheels for movement along the ground in an operating travel direction, the implement frame comprising a lateral frame member;
a plurality of disc assemblies substantially equally spaced along the lateral frame member, each disc assembly comprising a pivot bracket pivotally attached to the lateral frame member about a substantially vertical bracket pivot axis, and a disc arm attached to a lower portion of the pivot bracket, with a disc rotatably attached to a bottom end of the disc arm;
a control mechanism operative to pivot the pivot brackets of each disc assembly about the corresponding bracket pivot axis of each disc assembly to a selected operating position.

2. The implement of claim 1 wherein each disc assembly comprises an axle member attached at a mid-point thereof to the bottom end of the disc arm and right and left discs rotatably attached to corresponding right and left ends of the axle member.

3. The implement of claim 2 wherein rotational axes of the right and left discs are parallel and tilted from horizontal, and oriented one above the other such that lower edges of the right and left discs are at substantially the same vertical position.

4. The implement of claim 1 wherein each pivot bracket extends forward or rearward from the lateral frame member to a distal end thereof, and wherein the control mechanism comprises a control bar pivotally attached to a distal portion of each pivot bracket about a substantially vertical control pivot axis, and an actuator operative to move the control bar laterally.

5. The implement of claim 1 wherein each pivot bracket extends forward or rearward from the lateral frame member to a distal end thereof, and wherein the disc arm is pivotally is attached to a lower portion of a distal portion of the pivot bracket about a substantially horizontal arm pivot axis such that the disc arm can pivot upward from an operating position to a raised position, and a bias element operative to exert a downward bias force on the disc arm when the disc arm moves upward away from the operating position.

6. The implement of claim 1 wherein on each disc assembly, the bracket pivot axis substantially coincides with a rotational axis of the disc.

7. The implement of claim 1 wherein in each disc assembly:
the pivot bracket extends forward or rearward from the lateral frame member to a distal end thereof, and the disc arm is pivotally is attached to a lower portion of a distal portion of the pivot bracket about a substantially horizontal arm pivot axis such that the disc arm can move upward from an operating position to a raised position, and a bias element is operative to exert a downward bias force on the disc arm when the disc arm moves upward away from the operating position;
an axle member is attached at a mid-point thereof to the bottom end of the disc arm and right and left discs are rotatably attached to corresponding right and left ends of the axle member; and
the bracket pivot axis substantially coincides with rotational axes of the right and left discs.

8. The implement of claim 7 wherein the control mechanism comprises a control bar pivotally attached to the distal portion of each pivot bracket about a substantially vertical control pivot axis, and an actuator operative to move the control bar laterally.

9. The implement of claim 7 herein rotational axes of the right and left discs are parallel and tilted from horizontal, and one above the other such that lower edges of the right and left discs are at substantially the same vertical position.

10. The implement of claim 1 comprising front and rear lateral frame members and a plurality of disc assemblies substantially equally spaced along each of the front and rear lateral frame members.
